(19) United States
(12) Patent Application Publication
(10) Pub. No.: US 2026/0193040 A1
(43) Pub. Date: Jul. 9, 2026

(54) LONG-LIFE TRANSFER NOSE AND CONVEYOR

(71) Applicant: Laitram, L.L.C., Harahan, LA (US)

(72) Inventor: Gilbert J. MacLachlan, Harahan, LA (US)

(21) Appl. No.: 19/130,632

(22) PCT Filed: Dec. 1, 2023
(86) PCT No.: PCT/US2023/082039

§ 371 Date: May 16, 2025

Related U.S. Application Data
(60) Provisional application No. 63/432,142, filed on Dec. 13, 2022.

(51) Int. Cl. B65G 17/08

(52) U.S. Cl. CPC B65G 17/08

(57) ABSTRACT

A conveyor and a transfer nose for the conveyor that is especially suitable for tight product transfers. The transfer nose has a first face continuous with a carryway along which a modular conveyor belt advances. A second face is substantially perpendicular to the first face. A curved face is continuous with and disposed between the first and second faces. Optional nose roller bearings protrude from the curved face to reduce friction with the underside of the belt transiting from an upper carryway to a lower return. The 90° forward bend of the transfer nose from the first face to the second face reduces the bearing load on the nose rollers and extends their lives.

### BACKGROUND

The invention relates generally to power-driven conveyors and in particular to belt conveyors with tight transfer noses.

Short-pitch conveyor belts are often used to transfer products with small footprints across gaps between two end-to-end conveyors without intervening deadplates. Solid plastic nosebars or nose rollers at the outfeed and infeed of the belt conveyor are rounded by the conveyor belts as they transit between an upper carryway and a lower return. Typically, the nosebar or nose rollers redirect the belt by as much as 180° as it transits between the carryway and the return. As the nosebars or nose rollers wear, the gaps at the infeed and outfeed widen. When the gaps get wide enough as the nosebar or nose rollers wear, products with small footprints tip over during transfer from one conveyor to another. Manual intervention is required at first to remove or right tipped products and, after more wear, to replace the worn nosebars or nose rollers.

### SUMMARY

One version of a transfer nose around which a conveyor belt passes when transiting between an upper carryway and a lower return comprises a first face, a second face, a third face, and a first curved face. The first face forms a continuation of an upper carryway and has a first end at the upper carryway and an opposite second end. The second face is perpendicular to the first face and has a first end and a second end that is farther from the first face than is the first end. The first curved face is continuous with the first and second faces between the second end of the first face and the first end of the second face. The third face is oblique to the second face and extends below the first face.

Another version of a transfer nose around which a modular conveyor belt having a belt pitch passes when transiting between an upper carryway and a lower return comprises a first face, a second face, and a first curved face. The first face forms a continuation of an upper carryway and has a first end at the upper carryway and an opposite second end. The second face forms with the first face an interior angle of between 80° and 90° inclusive. The second face has a first end and a second end that is farther from the first face than is the first end. The first curved face is continuous with the first and second faces between the second end of the first face and the first end of the second face. The second face has a length that is at least one belt pitch in length.

One version of a conveyor comprises a conveyor belt and transfer nose between an upper carryway and a lower return. The transfer nose includes a first face that forms a continuation of the upper carryway and has a first end at the upper carryway and an opposite second end, a second face that is perpendicular to the first face and has a first end and a second end that is farther from the first face than is the first end, a first curved face continuous with the first and second faces between the second end of the first face and the first end of the second face, and a third face that is oblique to the second face and extends below the first face. The conveyor belt is configured to advance along the first, second, and third faces, the upper carryway, and the lower return.

### BRIEF DESCRIPTION OF THE DRAWINGS

FIG. 1 is a side elevation view of one version of a conveyor embodying features of the invention.

FIG. 2 is an isometric view of the transfer nose used in the conveyor of FIG. 1.

FIG. 3 is an isometric view of another version of a transfer nose usable in a conveyor as in FIG. 1.

### DETAILED DESCRIPTION

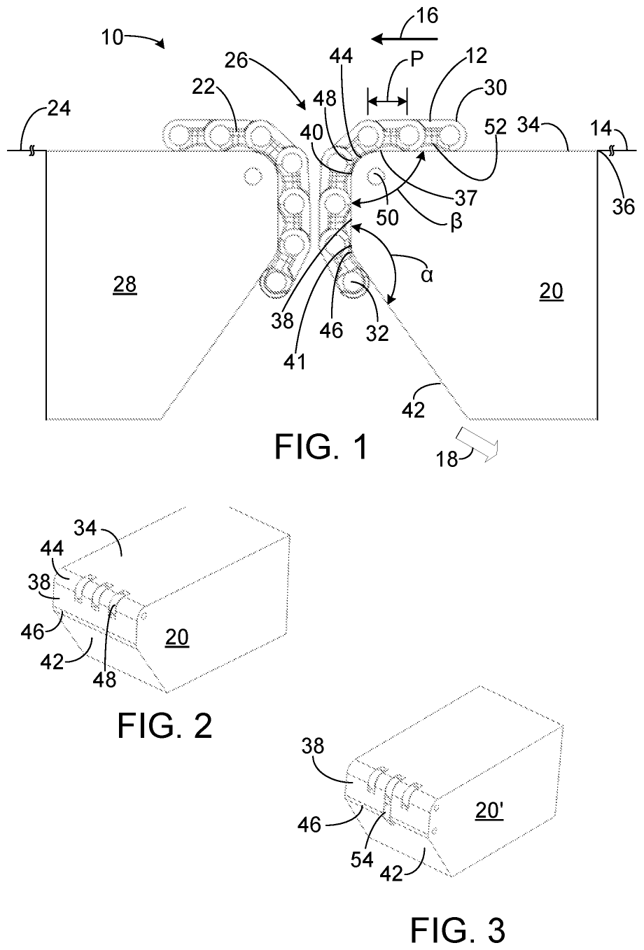

A conveyor embodying features of the invention is shown in FIG. 1. The conveyor 10 comprises a first conveyor belt 12 advancing along an upper carryway 14 in a direction of belt travel 16 from an upstream end to a downstream end. The conveyor belt 12 transits from the upper carryway 14 to a lower return 18 around a transfer nose 20, which can be unitarily formed. The conveyor belt 12 is conventionally engaged for driving by motor-driven sprockets or drive drums (not shown) in the return, for example. A second conveyor belt 22, also advancing in the same direction of belt travel 16, transits from a lower return to an upper carryway 24. Articles conveyed on the first conveyor belt 12 are transferred across a gap 26 to the second conveyor belt 22. The second conveyor belt 22 can be the same kind of belt as the first conveyor belt 12 and can use a similar transfer nose 28. But the two conveyor belts 12, 22 and the respective transfer noses 20, 28 can be different.

The first conveyor belt 12 is a modular plastic conveyor belt constructed of rows of plastic belt modules 30 joined end to end by hinge rods 32 at hinge joints at which the belt can articulate. The distance between consecutive hinge joints is the belt's pitch P.

The transfer nose 20 has five faces along which the first conveyor belt 12 rides. A first face 34 forms a continuation of the upper carryway 14. The first face 34 extends in the direction of belt travel 16 from a first end 36 to a second end 37. A second face 38 extends perpendicularly or close to perpendicularly down from the second end 37 of the first face 34. The length of the second face 38 is at least one belt pitch P. The second face 38 has a first end 40 and a lower second end 41 that is farther from the first face 41 than is the first end. A third face 42 is oblique to the second face 38 and extends below the first face 34. The second and third faces 38, 42 define an interior obtuse angle α. The first, second, and third faces 34, 38, 42 are shown as flat faces, but the third face could be curved or piecewise linear. The fourth face is a first curved face 44 that is continuous with the first and second faces 34, 38 between the second end of the first face and the first end of the second face. The fifth face is a short second curved face 46 that is continuous with the second and third faces 38, 42. It's possible for the transfer nose to be made without the second curved face 46, in which case the second face 38 would meet the third face 42.

The exemplary transfer nose 20 shown in FIG. 1 has a nose roller 48, such as a roller bearing, with a salient portion protruding outward of the first curved face 44. The nose roller 48 is freely rotatable on a shaft 50 and provides lower-friction rolling contact, rather than sliding contact, with the underside of the first conveyor belt 12. The belt's underside 52 is scalloped with a matching concave curvature equal or close to the convex curvature of the nose roller 48 to distribute the contact over a greater surface area and avoid high-pressure point contact. If a nose roller is not used, the curvature of the first curved face 44 and the curvature of the belt's underside 52 are equal or close to equal.

The perpendicular relationship of the second face to the first face reduces the bearing load on the nose roller bearings 48 or on the first curved face 38 if nose rollers aren't used. The bearing load on the nose rollers 48 increases as the interior angle β between the first and second faces decreases by a factor M=[2(1+cosβ)]^{1/2}, where β ranges from 90° to 0°. Over that range of interior angles β, M increases from √2(~1.414 ) for β=90° to 2 for β=0°. So the bearing load is about 30% less for β=90° than for the commonly used β=0°. And that translates into a more than doubled roller bearing life. Because interior angles of greater than 90° would cause interference with the second conveyor belt, they are not practical. So a bearing angle β of 90° or slightly less helps increase wear life. For β=80°, for which the second face 38 is 10° off vertical when the first face 34 is horizontal, or 10° off being perpendicular to the first face, the bearing load is only about 10% greater than for β=90°.

The transfer end of the transfer nose 20 is shown without the conveyor belt in FIG. 2. The nose rollers 48 are shown protruding slightly through the first curved face 44. The interrelationships of the first face 34, the second face 38, the third face 42, the first curved face 44, and the second curved face 46 are also shown.

Another version of a transfer nose is shown in FIG. 3. The transfer nose 20′ differs from the transfer nose 20 of FIG. 2 only in that it has a roller 54 protruding slightly from the second curved face 46 and the adjacent ends of the second and third faces 38, 42. Like the nose rollers 48, the roller 54 reduces friction and wear in both the transfer nose and the belt as the belt transits from the second face 38 to the third face 42. But because the forward bend of the transfer nose 20′ from the second face 38 to the third face 42 is less than the 90° bend from the first face 38 to the second face, the bearing load is not as great, and fewer rollers 54 are needed.

What is claimed is:

1. A transfer nose around which a conveyor belt passes when transiting between an upper carryway and a lower return, the transfer nose comprising:
a first face forming a continuation of an upper carryway and having a first end at the upper carryway and an opposite second end;
a second face perpendicular to the first face and having a first end and a second end farther from the first face than is the first end;
a first curved face continuous with the first and second faces between the second end of the first face and the first end of the second face;
a third face oblique to the second face and extending below the first face.

2. The transfer nose as claimed in claim 1 comprising at least one roller having a salient portion protruding from the first curved face.

3. The transfer nose as claimed in claim 1 comprising a second curved face continuous with the second and third faces.

4. The transfer nose as claimed in claim 3 comprising at least one roller having a salient portion protruding from the second curved face.

5. The transfer nose as claimed in claim 1 wherein the second face and the third face define an interior obtuse angle.

6. The transfer nose as claimed in claim 1 wherein the first, second, and third faces are flat.

7. The transfer nose as claimed in claim 1 wherein the transfer nose is a unitarily formed piece.

8. A transfer nose around which a modular conveyor belt having a belt pitch passes when transiting between an upper carryway and a lower return, the transfer nose comprising:
a first face forming a continuation of an upper carryway and having a first end at the upper carryway and an opposite second end;
a second face forming with the first face an interior angle of between 80° and 90° inclusive, the second face having a first end and a second end farther from the first face than is the first end;
a first curved face continuous with the first and second faces between the second end of the first face and the first end of the second face;
wherein the second face has a length that is at least as long as one belt pitch.

9. The transfer nose as claimed in claim 8 comprising a third face oblique to the second face and extending below the first face.

10. The transfer nose as claimed in claim 9 wherein the second face and the third face define an interior obtuse angle.

11. The transfer nose as claimed in claim 8 wherein the interior angle is 90°.

12. The transfer nose as claimed in claim 8 comprising at least one roller having a salient portion protruding from the first curved face.

13. The transfer nose as claimed in claim 12 comprising at least one roller having a salient portion protruding from the second curved face.

14. A conveyor comprising:
an upper carryway;
a lower return;
a transfer nose between the upper carryway and the lower return and including:
a first face forming a continuation of the upper carryway and having a first end at the upper carryway and an opposite second end;
a second face perpendicular to the first face and having a first end and a second end that is farther from the first face than is the first end;
a first curved face continuous with the first and second faces between the second end of the first face and the first end of the second face and having a curvature;
a third face oblique to the second face and extending below the first face;
a conveyor belt configured to advance along the first, second, and third faces, the upper carryway, and the lower return.

15. A conveyor as claimed in claim 14 wherein the conveyor belt has an underside scalloped with a curvature matched to the curvature of the first curved face to distribute contact between the underside of the conveyor belt and the first curved face over a greater area.

16. A conveyor as claimed in claim 14 wherein the transfer nose comprises at least one roller having a curvature and a salient portion protruding from the first curved face and wherein the conveyor belt has an underside scalloped with a curvature matched to the curvature of the at least one nose roller to distribute contact between the underside of the conveyor belt and the at least one roller over a greater area.
